(19) United States
(12) Patent Application Publication
(10) Pub. No.: US 2019/0272769 A1
(43) Pub. Date: Sep. 5, 2019

(54) INFORMATION PROCESSING DEVICE, INFORMATION PROCESSING METHOD, AND NON-TRANSITORY COMPUTER READABLE MEDIUM STORING INFORMATION PROCESSING PROGRAM

(71) Applicant: FUJI XEROX CO., LTD., Tokyo (JP)

(72) Inventors: Daisuke YASUOKA, Kanagawa (JP); Kiichiro ARIKAWA, Kanagawa (JP)

(73) Assignee: FUJI XEROX CO., LTD., Tokyo (JP)

(21) Appl. No.: 16/101,999

(22) Filed: Aug. 13, 2018

(30) Foreign Application Priority Data
Mar. 5, 2018 (JP) 2018-038809

(51) Int. Cl. G09B 7/04; G06K 9/00

(52) U.S. Cl. CPC G09B 7/04; G06K 2209/01; G06K 9/00456

(57) ABSTRACT

An information processing device includes: a presenter that presents evaluation criteria which indicate multiple evaluation viewpoints for evaluating an answer, and an allocation score corresponding to each of the multiple evaluation viewpoints; and an updater that, when editing of the evaluation criteria is received, updates the evaluation criteria.

### CROSS-REFERENCE TO RELATED APPLICATIONS

This application is based on and claims priority under 35 USC 119 from Japanese Patent Application No. 2018-038809 filed on Mar. 5, 2018.

### BACKGROUND

### Technical Field

The present invention relates to an information processing device, an information processing method, and a non-transitory computer readable medium storing an information processing program.

### SUMMARY

According to an aspect of the invention, there is provided an information processing device including: a presenter that presents evaluation criteria which indicates multiple evaluation viewpoints for evaluating an answer, and an allocation score corresponding to each of the multiple evaluation viewpoints; and an updater that, when editing of the evaluation criteria is received, updates the evaluation criteria.

### BRIEF DESCRIPTION OF THE DRAWINGS

Exemplary embodiments of the present invention will be described in detail based on the following figures, wherein:

FIG. 1 is a diagram illustrating the schematic configuration of an information processing system according to an exemplary embodiment of the invention;

FIG. 2 is a block diagram illustrating an example of a hardware configuration of the information processing device;

FIG. 3 is a block diagram illustrating an example of a functional configuration of the information processing device;

FIG. 4 is a table illustrating an example of evaluation criteria table;

FIG. 5 is a flowchart illustrating the flow of information processing performed by the information processing device;

FIG. 6 is a view illustrating an example of a screen displayed on a grader terminal;

FIG. 7 is a view illustrating an example of a screen indicating a result of re-grading associated with update of evaluation criteria;

FIG. 8 is a view illustrating an example of a screen depicting answer sheets side by side before and after update of evaluation criteria;

FIG. 9 is a view illustrating an example of a screen displaying another case;

FIG. 10 is a view illustrating an example of a screen including a free section;

FIG. 11 is a view illustrating an example of a screen which displays a free board;

FIG. 12 is a diagram illustrating an operating mode of an information processing device in a third additional exemplary embodiment;

FIG. 13 is a view illustrating an example of a screen indicating association between grading results and evaluation criteria;

FIG. 14 is a view illustrating an example of a screen which indicates grading results based on evaluation criteria associated with the grading results, and grading results in handwriting by comparison;

FIG. 15 is a diagram illustrating an operating mode of an information processing device in a fourth additional exemplary embodiment;

FIG. 16 is a view illustrating an example of a screen which indicates results of grading by multiple graders by comparison;

FIG. 17 is a view illustrating an example of a screen which indicates the details of results of grading by multiple graders by comparison; and

FIG. 18 is a table illustrating an example of another evaluation criteria table.

### DETAILED DESCRIPTION

Hereinafter, an exemplary embodiment of the present invention will be described with reference to the drawings. It is to be noted that the same or equivalent components and parts in the drawings are labeled with the same reference symbol. Also, the dimension ratio in the drawings is significantly changed for the sake of convenience of description, and may be different from the actual ratio.

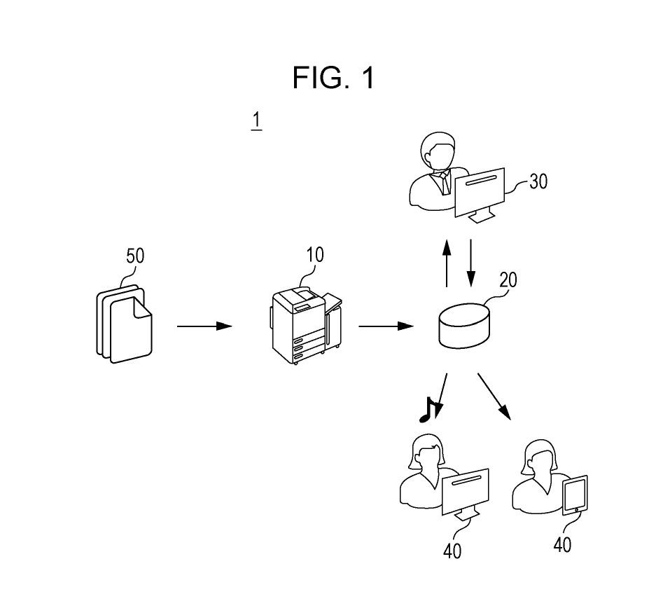

FIG. 1 is a diagram illustrating the schematic configuration of an information processing system according to an exemplary embodiment of the invention.

As illustrated in FIG. 1, an information processing system 1 includes an image acquisition device 10, an information processing device 20, a grader terminal 30, and examinee terminals 40.

The image acquisition device 10 is a device that acquires images of answer sheets 50 written by examinees. The image acquisition device 10 acquires image data of the answer sheets, for instance, by scanning the answer sheets 50. The image acquisition device 10 may be, for instance, a multifunctional device capable of performing functions such as scanning, printing, and copying, or may be a device having only a scan function. Alternatively, the image acquisition device 10 may be an imaging device such as a camera that captures the answer sheets 50. The image acquisition device 10 may include an optical character recognition reader that extracts characters from read image data and recognizes the characters.

The information processing device 20 is a device that supports grading of the answer sheets 50. The information processing device 20 acquires image data of the answer sheets 50 from the image acquisition device 10, and allows the image of the answer sheets 50 along with information used for grading by a grader to be viewed at the grader terminal 30. The details of the information processing device 20 will be described later.

The grader terminal 30 is a terminal used by a grader, and can transmit and receive information to and from the information processing device 20. For instance, a grader is assigned specific user ID and password in advance, and when the grader inputs the user ID and password via the grader terminal, the information processing device 20 permits access via the grader terminal 30. The grader grades answer sheets by reference to information from the information processing device 20 at the grader terminal 30.

The examinee terminals 40 are terminals to be used by the examinees who have written the answer sheets 50. The information processing device 20 transmits a result of grading to each the examinee terminals 40, thus each of the examinees can check the result of grading.

Next, the hardware configuration of the information processing device 20 will be described.

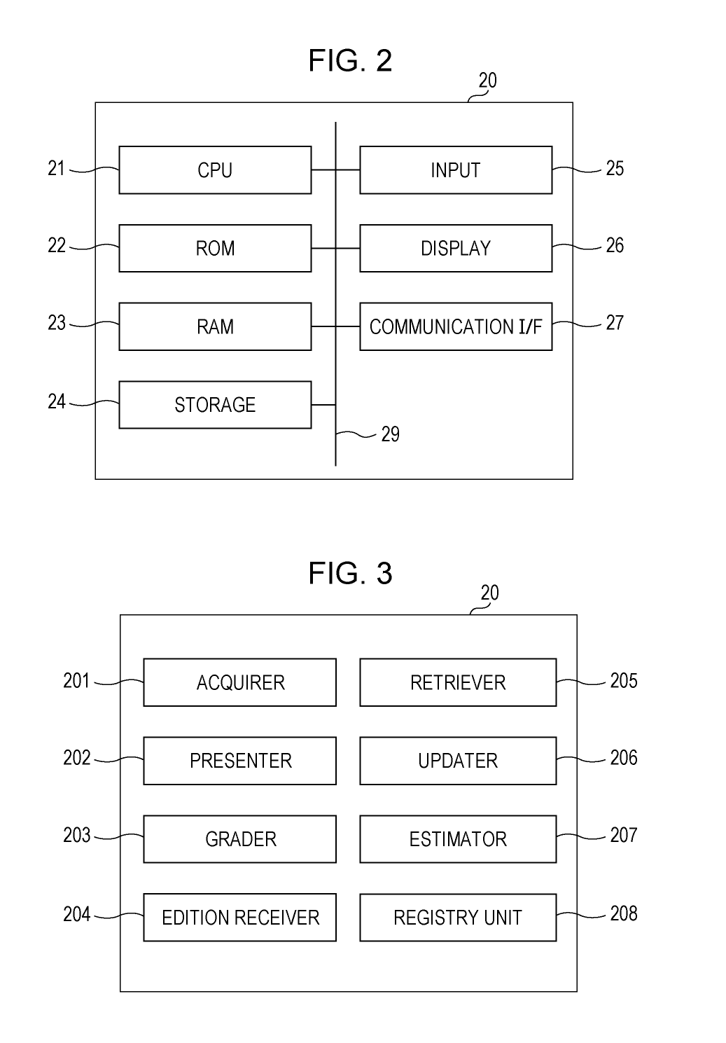

FIG. 2 is a block diagram illustrating an example of a hardware configuration of the information processing device.

As illustrated in FIG. 2, the information processing device 20 includes the components: a central processing unit (CPU) 21, a read only memory (ROM) 22, a random access memory (RAM) 23, a storage 24, an input 25, a display 26, and a communication interface 27. The components are coupled to each other via a bus 29 to allow communication therebetween.

The CPU 21 is a central processing unit, and executes various programs and controls each component. Specifically, the CPU 21 reads a program from the ROM 22 or the storage 24, and executes the program using the RAM 23 as a workspace. The CPU 2 controls the components and performs various types of calculation processing in accordance with programs stored in the ROM 22 or the storage 24. In the exemplary embodiment, the ROM 22 or the storage 24 stores an information processing program that supports grading.

The ROM 22 stores various programs and various types of data. The RAM 23 serves as a workspace to temporarily store programs or data. The storage 24 is configurated by a hard disk drive (HDD) or a solid state drive (SSD), and stores various programs including an operating system, and various types of data.

The input 25 includes a pointing device such as a mouse, and a keyboard, and is used to perform various inputs.

The display 26 is, for instance, a liquid crystal display, and displays various types of information. The display 26 adopts a touch-panel, and may function as the input 25.

The communication interface 27 is an interface for communicating with other devices such as the image acquisition device 10, the grader terminal 30, and the examinee terminals 40, and for instance, standards such as Ethernet (registered trademark), FDDI, and Wi-Fi (registered trademark) are used.

Next, the functional configuration of the information processing device 20 will be described.

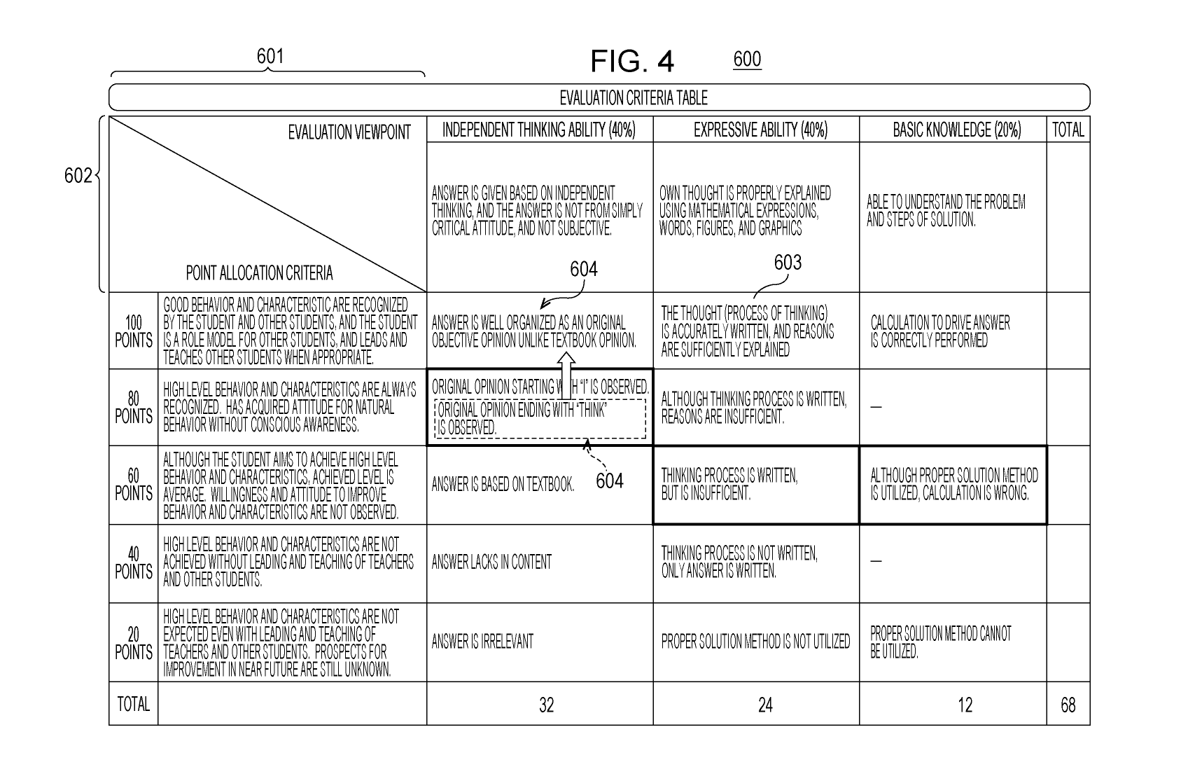

FIG. 3 is a block diagram illustrating an example of the functional configuration of the information processing device. FIG. 4 is a table illustrating an example of an evaluation criteria table.

As illustrated in FIG. 3, the information processing device 20 includes an acquirer 201, a presenter 202, a grader 203, an edition receiver 204, a retriever 205, an updater 206, an estimator 207, and a registry unit 208 as the functional configuration. The functional configuration is implemented by the CPU 21 that reads the information processing program stored in the ROM 22 or the storage 24, and loads and executes the information processing program in the RAM 23.

The acquirer 201 acquires the image data of each of the answer sheets 50. In the image acquisition device 10, when characters written in the answer sheet 50 are recognized, the acquirer 201 also acquires character data together.

The presenter 202 presents evaluation criteria indicating evaluation viewpoints for evaluating answers, and allocation scores corresponding to the evaluation viewpoints. Hereinafter, a case is described in which the presenter 202 presents multiple evaluation criteria, particularly as an aggregate table of the multiple evaluation criteria indicating multiple evaluation viewpoints for evaluating answers, and respective allocation scores corresponding to the multiple evaluation viewpoints. A table, in which multiple evaluation criteria are aggregated, is called an evaluation criteria table. It is to be noted that evaluation criteria do not have to be presented in the table format described below. In other words, the presenter 202 may present evaluation criteria in which one evaluation viewpoint and one allocation score correspond to each other. Alternatively, the presenter 202 may present evaluation criteria not only with display but also voice.

The evaluation criteria table includes a first array in which multiple evaluation viewpoints for evaluating answers are arranged, and a second array in which allocation scores in multiple stages are arranged, and defines the evaluation criteria corresponding to combinations of an evaluation viewpoint and an allocation score. The presenter 202 causes, for instance, the display provided in the grader terminal 30 to display an evaluation criteria table, and allows a grader to utilize the evaluation criteria table at the grader terminal 30. For instance, like an evaluation criteria table 600 illustrated in FIG. 4, the evaluation criteria table is a table represented as a matrix including items in an array 601 (second array) which indicate criteria for point allocation, and items in an array 602 (first array) which indicate evaluation viewpoints of point allocation. In the array 601 which indicates criteria for allocation scores, the values of allocation scores, and a description of criteria for each allocation score are listed, for instance, in descending order of allocation score. In the array 602 which indicates evaluation viewpoints, the titles indicating the concepts of evaluation viewpoints such as “independent thinking power”, “expressive power”, and “basic knowledge” for instance, and a description of each evaluation viewpoint are listed. Each evaluation viewpoint is assigned a contribution rate (%) to be used for grading. Thus, a weight according to significance of each evaluation viewpoint is provided. An evaluation criterion 604 is shown for each of events 603 which are determined by the combinations of the items of the array 601 and the items of the array 602. The evaluation criterion indicates a specific criterion expected as an answer, for instance, “Answer is well organized as an original objective opinion unlike textbook opinion”. In the example in FIG. 4, there are 5 rows×3 columns=15 pieces of events 603, however, the reference number 603 is assigned to only one event, and assignment of the reference number 603 to the remaining events is omitted. A grader checks the answer on an answer sheet against the evaluation criterion 604 for each event 603, and selects an evaluation criterion 604 which is met. When an evaluation criterion 604 for an answer is selected, for instance, an event 603, in which the evaluation criterion 604 is defined, is selected (clicked). The score of the answer is determined by the product of the allocation score (0 to 100 points) for the selected event and a contribution rate (higher than 0% and lower than or equal to 100%). FIG. 4 is only an example of the evaluation criteria table 600, and the exemplary embodiment is not limited to FIG. 4. Any type of evaluation criteria table may be used as long as the evaluation criteria table is suitable for evaluation of answers of what is called comprehensive thinking questions in which performance such as “thinking”, “judging”, and “expressive” ability. Also, the allocation score may not be a specific numerical value, and may be a level represented by an alphabet.

From the evaluation criteria table 600 presented by the presenter 202, the grader 203 receives selection of an evaluation viewpoint and an allocation score, which are used as evaluation of answers, of the evaluation criterion 604, and grades the answer with a score corresponding to the selected evaluation viewpoint and allocation score. Specifically, the grader 203 receives selection of the event 603 of the evaluation criteria table 600 as the selection of an evaluation viewpoint and an allocation score, identifies the evaluation viewpoint and the allocation score corresponding to the selected event 603, and obtains a score by multiplying the identified allocation score by the contribution rate of the evaluation viewpoint. For instance, a grader refers to the evaluation criteria table 600 as illustrated in FIG. 4, and selects an event 603 which includes applicable evaluation criteria 604 for the answer on an answer sheet. When a grader selects the event 603, both evaluation viewpoint and allocation score corresponding to the selected event 603 are selected. A score is determined by multiplying the selected allocation score by the contribution rate of the evaluation viewpoint. The grader 203 totals the scores determined in this manner. Hereinafter, a score based on the contribution rate of an evaluation viewpoint and an allocation score corresponding to the selected evaluation criteria 604 is simply referred to as a score corresponding to the selected evaluation criteria 604, or a score corresponding to the selected event 603.

The edition receiver 204 can receive edition the evaluation criteria 604 of the evaluation criteria table 600. The edition receiver 204 allows a grader, for instance, while grading answers at the grader terminal 30 to directly edit the evaluation criteria table 600 displayed on the display. The editing is instructed, for instance, by an input device such as a mouse or a keyboard provided in the grader terminal 30. The editing of evaluation criteria is, for instance, moving the evaluation criteria 604 surrounded by a dotted line to another event 603 as indicated by an arrow in FIG. 4. When the event 603 to which the evaluation criteria 604 belongs is changed like this, the allocation score for the evaluation criteria 604 is changed. In addition, the edition receiver 204 also receives addition of new evaluation criteria 604 to the event 603, and deletion of existing evaluation criteria 604. The edition receiver 204 may also receive editing of specific numerical values of allocation score, such as 100 points, 80 points in FIG. 4, editing combination of the concepts of evaluation viewpoints such as independent thinking ability, and editing of the numerical value of the contribution rate of an evaluation viewpoint, such as 40%. In other words, the edition receiver 204 can receive all types of editing of the evaluation criteria table 600.

The retriever 205 retrieves from the database other evaluation criteria 604 similar or related to evaluation criteria 604 presented by the presenter 202. It is to be noted that the retriever 205 may also retrieve from the database another evaluation criteria table 600 similar or related to an evaluation criteria table 600 presented by the presenter 202. For instance, when a grader desires to refer to an evaluation criteria table used in the past or an evaluation criteria table used in another school for grading the answers on answer sheets, the retriever 205 retrieves a similar or related evaluation criteria table from the database. The database may be held in the information processing device 20 or an external server. Also, a degree of similarity between evaluation criteria tables is determined, for instance, by an agreement rate between the natural sentences included in the evaluation criteria tables. The retriever 205 determines the degree of similarity to be higher for higher agreement rate between the natural sentences. Alternatively, when information on questions for testing comprehensive thinking ability is included in the evaluation criteria table 600, the retriever 205 can determine the correlation between the evaluation criteria tables 600 based on the degree of similarity between questions. For instance, when the evaluation criteria table 600 used for the grading this time includes information on the question “describe the vegetable stores in your local area”, the retriever 205 determines that an evaluation criteria table including information on the question “describe the fish stores in your local area” is a related evaluation criteria table. This is because the two questions are similar to each other based on the common concept of “describe the stores in your local area”. Alternatively, when the evaluation criteria table 600 is assigned symbols, numerals, or characters for classification, the retriever 205 can determine evaluation criteria tables having matching symbols are related evaluation criteria tables. For determination of a degree of similarity between evaluation criteria tables, known techniques for retrieving natural sentences are applicable, and without being limited to the above-described techniques, a degree of similarity may be determined by any criterion.

When editing is received by the edition receiver 204, the updater 206 updates the evaluation criteria table 600 to reflect the editing to grading by the grader 203. Update of the evaluation criteria table 600 refers to, for instance, updating the evaluation criteria table 600 stored as master data in the storage 24 of the information processing device 20. Update of the evaluation criteria table 600 allows answers which have been already graded to be re-graded using the evaluation criteria table 600 updated.

When the image data of the answer sheet 50 acquired by the acquirer 201 is the image data of answer sheet 50 which has been graded in handwriting, the estimator 207 estimates from the image data the event 603 of the evaluation criteria table 600 selected for grading when obtaining a grading result. For instance, from the image data, the estimator 207 first recognizes the image of a score and/or a symbol written by a grader on the answer sheet. Here, the symbol is associated with a specific evaluation viewpoint. Thus, the estimator 207 identifies a corresponding evaluation viewpoint from the recognized symbol. In addition, the estimator 207 identifies which event of the evaluation criteria table is used, based on the identified evaluation viewpoint and the score written on the answer sheet. For instance, when the identified evaluation viewpoint is “independent thinking ability” and the score written on the answer sheet is “32 points”, the estimator 207 can estimate that the allocation score satisfying both evaluation viewpoint and score is “80 points” with reference to the evaluation criteria table 600 illustrated in FIG. 4. Therefore, the estimator 207 can estimate that the event 603 determined by the combination of the evaluation viewpoint “independent thinking ability” and the allocation score “80 points” has been selected, in other words, the evaluation criteria 604 belonging to the event 603 has been adopted. In this manner, the estimator 207 estimates the adopted evaluation criteria.

The registry unit 208 registers part or all of answers from the image data of the answer sheet 50 to allow the part or all of answers to be referenced when another answer is graded or after another answer is graded. The registry unit 208 provides a free section in which a grader can freely register data, and allows a grader to freely paste the image of part of the answer, rearrange pasted images, and input characters on the free section.

Next, the operation of the information processing device 20 will be described.

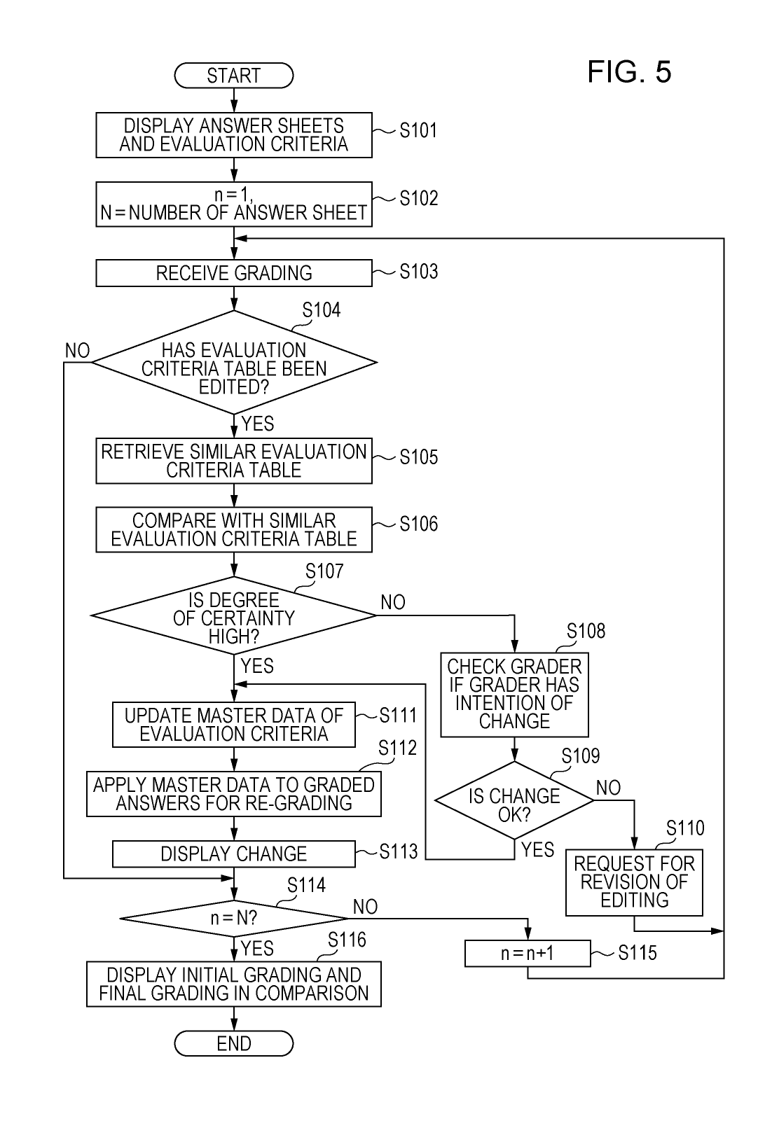

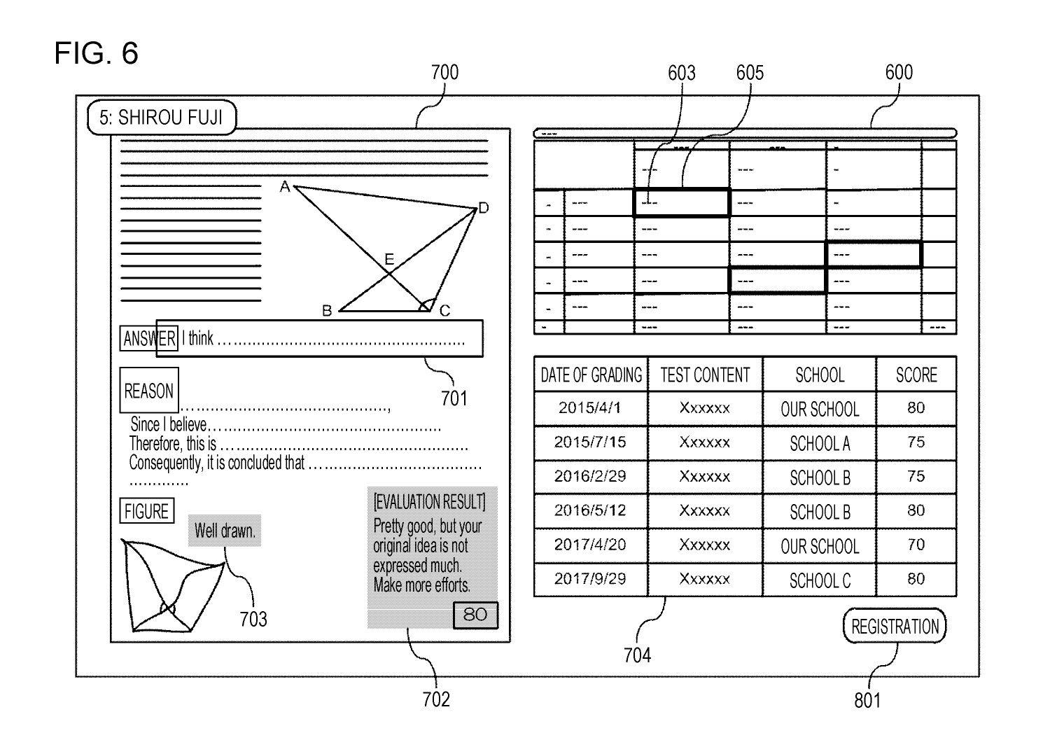

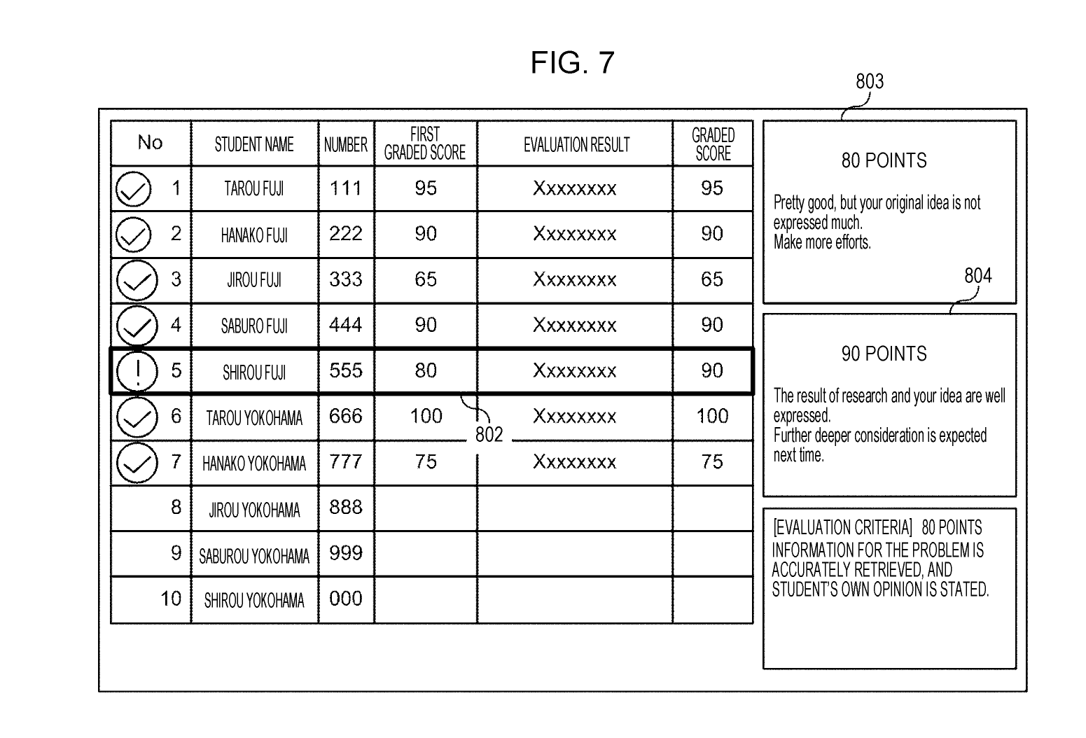

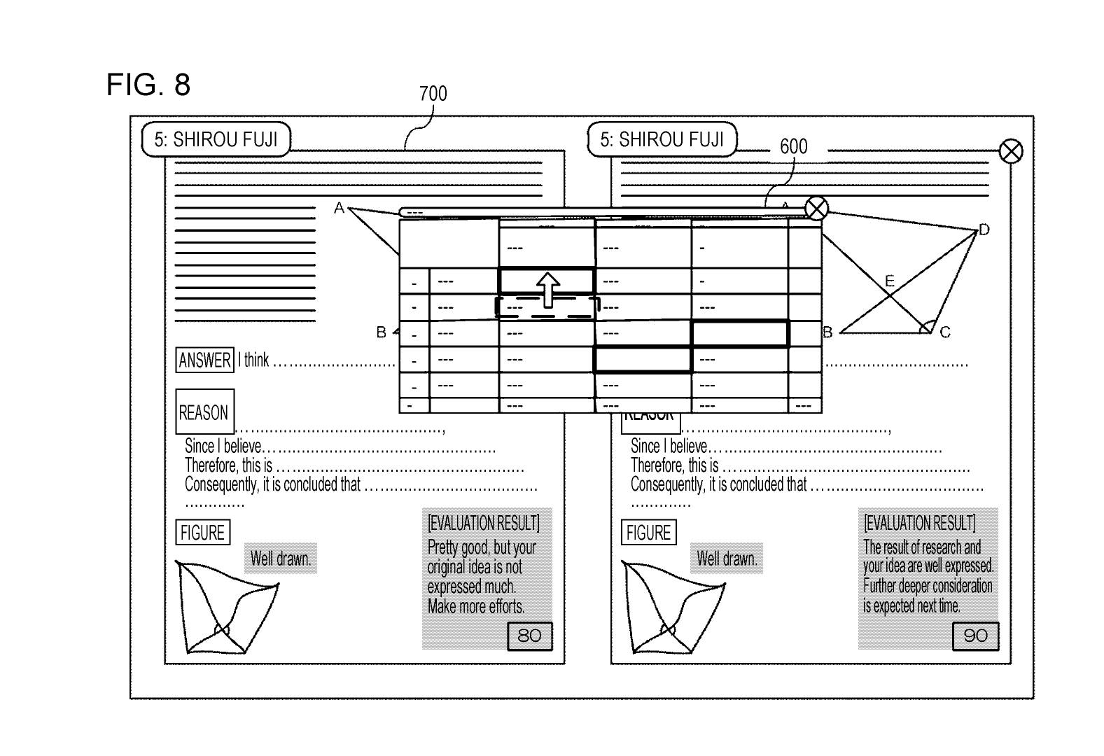

FIG. 5 is a flowchart illustrating the flow of information processing performed by the information processing device. The information processing is performed by the CPU 21 that reads an information processing program from the ROM 22 or the storage 24, and loads and executes the information processing program in the RAM 23. FIG. 6 is a view illustrating an example of a screen displayed on a grader terminal. FIG. 7 is a view illustrating an example of a screen indicating a result of re-grading associated with update of evaluation criteria. FIG. 8 is a view illustrating an example of a screen depicting answer sheets side by side before and after update of evaluation criteria.

The CPU 21 displays the image of answer sheets to be graded as the presenter 202, and the evaluation criteria 604 for grading the questions of answer sheets as the evaluation criteria table 600 (step S101). For instance, as illustrated in FIG. 6, an image 700 of an answer sheet and the evaluation criteria table 600 are displayed side by side on the display of the grader terminal 30. The evaluation criteria table 600 used for the current grading is determined, for instance, by the selection of a grader. Alternatively, the CPU 21 may determine a corresponding or related evaluation criteria table 600 using the questions on the answer sheet as keywords. The CPU 21 inputs 1 to n, and N to the number of answer sheets as initial values (step S102).

The CPU 21 receives grading by a grader as the grader 203 (step S103). Grading by a grader is performed by selecting appropriate events 603 each indicating an evaluation viewpoint suitable to the answer from the evaluation criteria table 600, for instance, on the screen illustrated in FIG. 6. The selected events 603 are displayed highlighted with a thick frame 605, for instance. A score is calculated by multiplying a contribution rate by an allocation score based on the highlighted event 603 displayed, and the total of scores of the selected events gives a grading result. When receiving grading, the CPU 21 also receives editing of the evaluation criteria table 600 as the edition receiver 204. The receiving of grading is completed by “registration” button 801 of a screen being selected by click etc.

When the grading is completed, the CPU 21 determines whether or not editing has been performed on the evaluation criteria 604 of the evaluation criteria table 600 in the grading (step S104). When editing has not been performed (NO in step S104), the CPU 21 causes the processing to proceed to step S114. When editing has been performed (YES in step S104), as the retriever 205, the CPU 21 retrieves from an internal or external database an evaluation criteria table similar or related to the evaluation criteria table 600 used for the grading this time (step S105).

The CPU 21 compares the portion involved in editing of the evaluation criteria table 600 used for grading with the evaluation criteria table obtained by the retrieval (step S106). For instance, when new evaluation criteria 604 has been added to one of the events 603 as the editing of the evaluation criteria table 600, the CPU 21 makes comparison to see whether the added new evaluation criteria 604 is the same as or similar to one of the existing evaluation criteria in other evaluation criteria tables. When the added evaluation criteria 604 is the same as or similar to one the existing evaluation criteria, the CPU 21 determines that the certainty of the added evaluation criteria is high, in other words, the probability of editing of the evaluation criteria table is high. It is to be noted that whether the added evaluation criteria 604 is the same as or similar to one the existing evaluation criteria can be determined by the agreement rate between the characters included in the new evaluation criteria and the characters included in an existing evaluation viewpoint. When the agreement rate between the characters is, for instance, 80% or higher, the CPU 21 determines that the new evaluation criteria is similar to the existing evaluation criteria. It is to be noted that 80% is only an example, and any threshold may be set instead of 80%. Alternatively, when the evaluation criteria 604 is changed (moved) from an event corresponding to 80 points of allocation score to an event corresponding to 100 points as indicated by the arrow of FIG. 4 as the editing of the evaluation criteria table 600. The CPU 21 determines whether the same or similar existing evaluation criteria are present in an event corresponding to 100 points in other evaluation criteria tables. When the same or similar existing evaluation criteria are present, the CPU 21 determines that the probability of editing of the evaluation criteria table is high.

The CPU 21 determines whether or not the probability of editing of the evaluation criteria table 600 has been determined to be high in step S106 (step S107). When the probability has not been determined to be high (NO in step S108), the CPU 21 asks a grader if the grader has the intention of editing (step S108). For instance, the CPU 21 displays a message something like “Is it OK to finalize the editing of the evaluation criteria? When the editing is finalized, the change reflects to the other graded answer sheets” on the display of the grader terminal 30, and lets a grader choose “YES (positive)” or “NO (negative)”.

When the grader negates the intention of editing the evaluation criteria table 600 (NO in step S109), the CPU 21 requests the grader to review the editing of the evaluation criteria 604 (step S110). For instance, the CPU 21 displays a message something like “The evaluation criteria have returned to the state before editing. Please grade the answer sheet again.”, and the flow returns to the processing in step S103. When the grader gives a positive reply to the intention of editing the evaluation criteria table 600 (YES in step S109), the flow proceeds to processing in step S111.

The CPU 21 updates the master data of the evaluation criteria 604, specifically, the master data of the evaluation criteria table 604 in which the evaluation criteria 604 are aggregated (step S111). The CPU 21 applies the master data of the updated evaluation criteria table 600 to the answer sheets which have been already graded, and re-grades those answer sheets (step S112), and displays a result of re-grading (step S113). The result of re-grading is displayed on the display of the grader terminal 30, for instance, as illustrated in FIG. 7. In the screen example illustrated in FIG. 7, the result of grading based on the evaluation criteria table 600 before update are listed in the column of “FIRST GRADED SCORE”, and the result of grading based on the updated evaluation criteria table 600 are listed in the column of “GRADED SCORE”. FIG. 7 illustrates that the result of grading of No. 5 student (examinee) has changed according to the update of the evaluation criteria table 600. When any student is selected in the table, a selected row is displayed highlighted like a thick frame 802. When a student is selected, an evaluation comment 803 at the time of the first grading and an evaluation comment 804 at the time of grading based on the updated evaluation criteria table 600 may displayed side by side. In addition, when a student surrounded the thick frame 802 is selected, transition to the screen illustrated in FIG. 8 may be made, and the answer sheets of the selected student before and after the update of the evaluation criteria table 600 may be displayed side by side. Here, how the evaluation criteria or the allocation score has changed is clearly displayed before and after the update of the evaluation criteria table 600. For instance, the portion affected by the change is indicated by surrounding the portion with a dotted line frame, or displayed in a color different from the color of other characters.

The CPU 21 determines whether or not n=N, in other words, grading of all the answer sheets has been finished (step S114). When grading of all the answer sheets has not been finished (NO in step S114), the CPU 21 increments n by just 1 (step S115), and the flow returns to the processing in step S103.

When grading of all the answer sheets has been finished (YES in step S114), the CPU 21 displays the initial grading and the final grading by comparison (step S116). In step S113, each time the evaluation criteria table 600 is updated, the difference between grading results before and after the update is displayed. In step S116, when the evaluation criteria table 600 is updated multiple times, regardless of a difference before and after each update of the evaluation criteria table 600, the grading result at the time of the first grading and the grading result after the final update are displayed by comparison. Since the screen to be displayed is similar to the screen of FIG. 7, illustration of the screen is omitted.

The information processing device 20 is not limited to the above-described exemplary embodiment. Various improvements and modifications may be added to the information processing device 20. Hereinafter, additional exemplary embodiments of the information processing device 20 will be described.

### First Additional Exemplary Embodiment

Referring to FIG. 6 again, a first additional exemplary embodiment will be described.

In the first additional exemplary embodiment, the information processing device 20 allows a grader to select part of an answer sheet and the event 603 (or the evaluation criteria 604) of the evaluation criteria table 600, associates the selection portion selected by the grader with the event 603 (or the evaluation criteria 604). Consequently, an adopted event 603 is associated with an evidence in an answer sheet. For instance, the information processing device 20 stores the selection portion indicated by surrounding with a frame 701 in FIG. 6 in association with the event 603 surrounded by the thick frame 605. For instance, when the event with the thick frame 605 is clicked, a corresponding part of the answer sheet is explicitly displayed surrounded by the frame 701 due to the association. Conversely, when a point within the range of the frame 701 is clicked, a corresponding event 603 may be displayed highlighted with color changing of the thick frame 605.

Also, the information processing device 20 allows a grader to make a comment on the image 700 of the answer sheet. A comment is made on the image 700 of the answer sheet, for instance, like stickies 702, 703. The stickies 702, 703 may be associated with the entire answer sheet or part of the answer sheet. For instance, the sticky 703 is associated with part of a figure as an evaluation for a description using the figure. In this case, a grader can select a range to be associated with the sticky 703 by a mouse or the like.

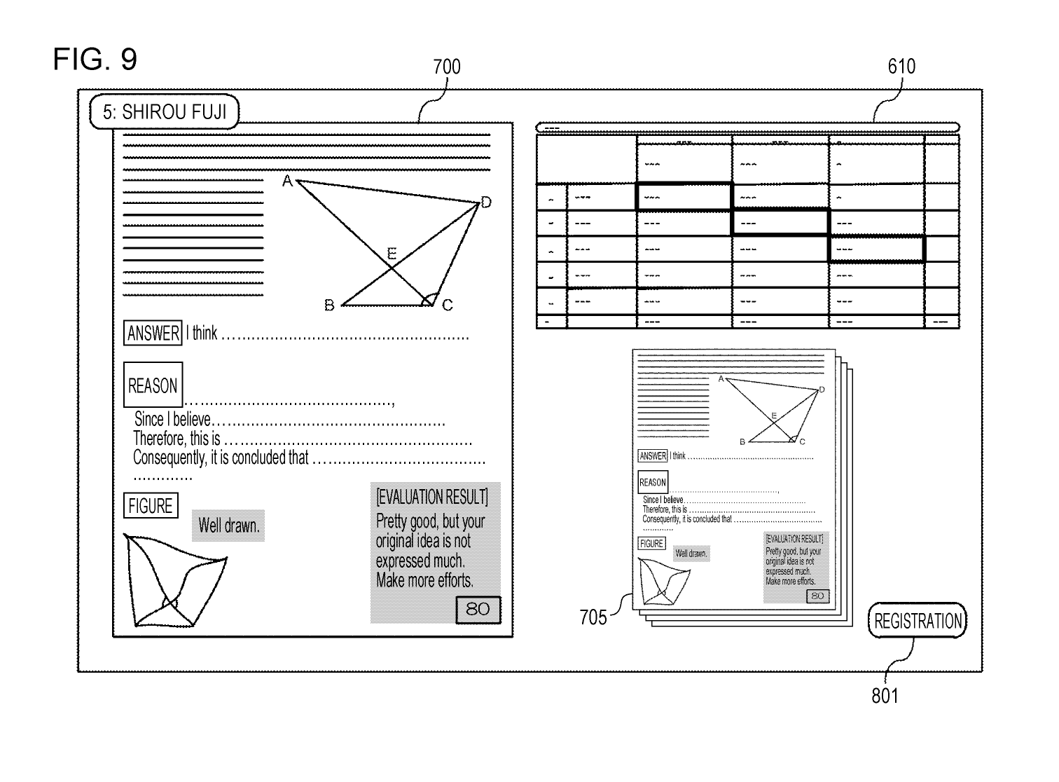

In addition, the information processing device 20 presents a table 704 of cases (such as tests) in the past related to the questions of the answer sheet, and cases in other areas (other schools) as a reference chart. The cases illustrated in the table 704 are retrieved from a database in the storage 24 or an external database by the retriever 205. At this point, the retriever 205 can retrieve related cases in the past based on, for instance, the similarity between questions. More specifically, the natural sentences included in the questions of answer sheets this time are compared with the natural sentences included in the cases in the database, and the titles of cases are displayed in the table 704 in descending order of agreement rate. The retriever 205 may have a filtering function, and may set a range for searching in accordance with conditions, for instance, whether certain seasons (periods), areas, and our school are included. The titles of cases are selectable by clicking or the like when one of cases is selected, the details of the case are illustrated as in FIG. 9.

FIG. 9 is a view illustrating an example of a screen displaying another case.

As illustrated in FIG. 9, a case 705 selected in FIG. 6 is displayed on the lower right of the screen. The case 705 is, for instance, one of the answer sheets in the past cases. All the answer sheets included in the past cases may be referenced by feeding pages or the like, or only one answer sheet may be referenced as a sample. In the case 705, comments of a grader at the time of grading are also displayed.

Also, instead of the evaluation criteria table 600 related to the grading this time, the evaluation criteria table 610 in the past case may be displayed above the display of the case 705. In this case, in the evaluation criteria table 610, the evaluation criteria adopted in the case 705 is displayed highlighted. A grader can refer to evaluation criteria adopted by the grader or another person in the past case.

### Second Additional Exemplary Embodiment

In a second additional exemplary embodiment, as the registry unit 208, the information processing device 20 registers part or all of answers from the image data of the answer sheet 50 to allow the part or all of answers to be referenced when another answer is graded or after another answer is graded. The information processing device 20 allows a grader to freely leave a note.

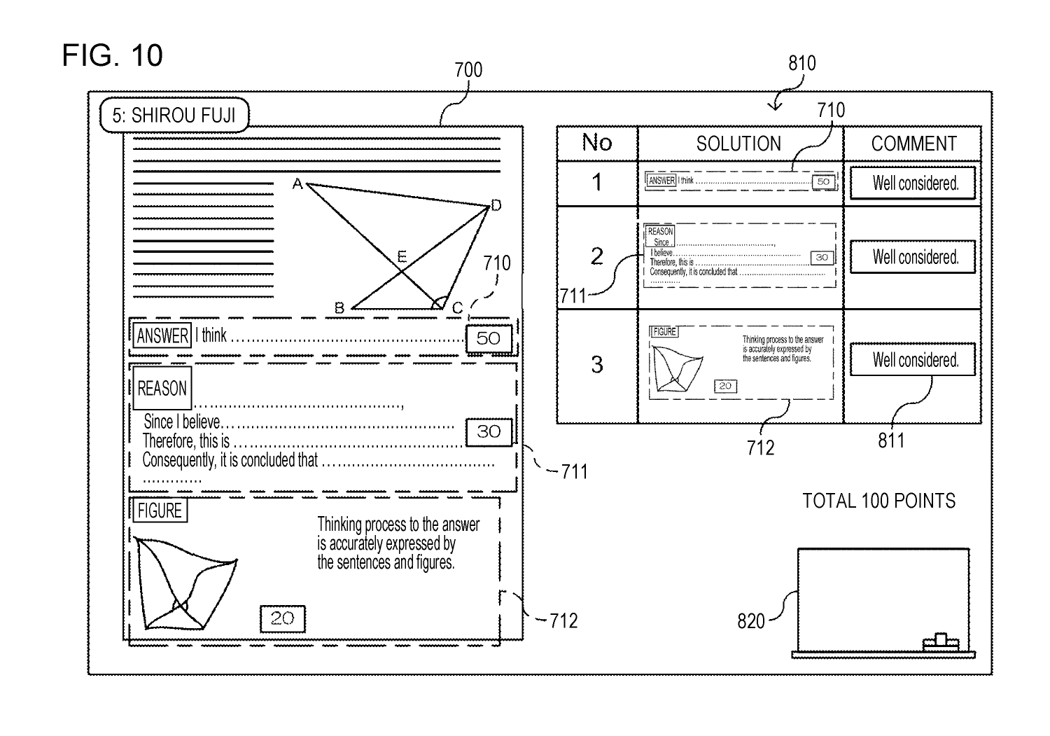

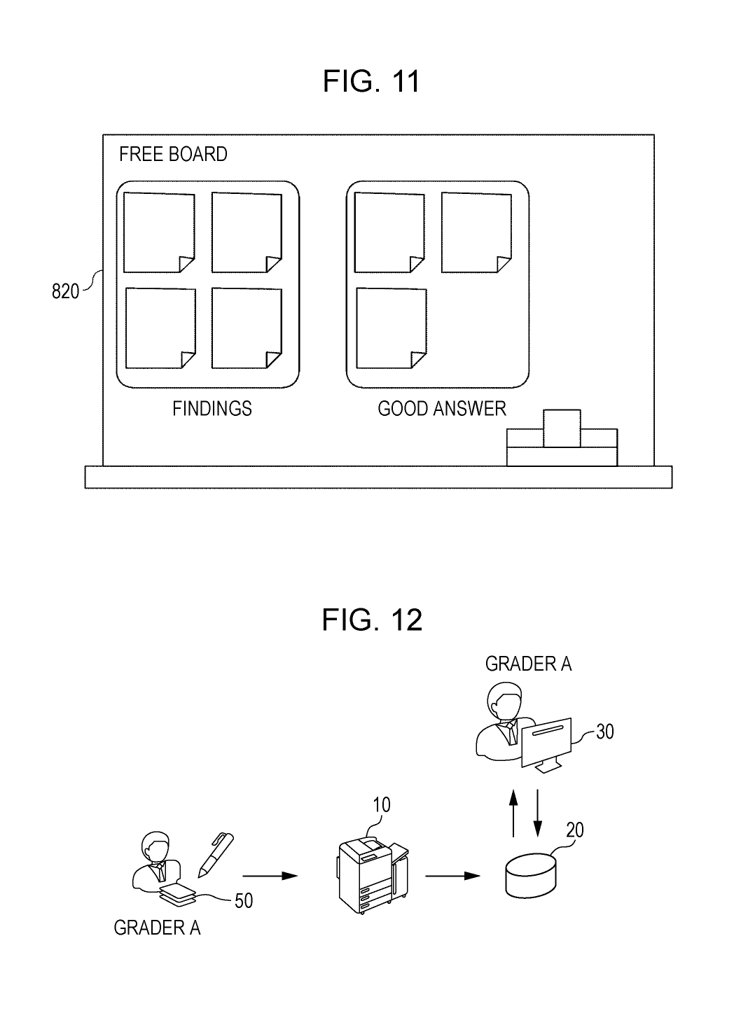

FIG. 10 is a view illustrating an example of a screen including a free section. FIG. 11 is a view illustrating an example of a screen which displays a free board.

As illustrated in FIG. 10, the information processing device 20 may provide a free section 810, in which a grader can freely leave a note, adjacent to the image 700 of the answer sheet. In the free section 810, for instance, images 710 to 712 of part of the answer in the answer sheet are cut out and pasted. Also, a comment 811 or the like of a grader may be made in association with the cut out images 710 to 712 of part of the answer. The free section 810 can be referenced freely not matter which answer is graded.

Also, the free section 810 includes a free board 820 which is largely displayed only when selected. When the free board 820 is selected by clicking, as illustrated in FIG. 11, the information processing device 20 enlarges the free board 820 and displays the screen. In the free board 820, the image of part of an answer cut out from the image of an answer sheet can be freely pasted, and pasted images can be grouped. In the example illustrated in FIG. 11, images related to findings obtained by a grader while grading answer sheets, and images of good answers written on answer sheets are grouped. In addition to images cut out from answer sheets, any information such as text information, graphic information, photograph information, voice information, and video information can be added to the free board 820. Also, the added information can be freely deleted.

### Third Additional Exemplary Embodiment

In a third additional exemplary embodiment, as the acquirer 201, the information processing device 20 acquires the image data of the answer sheet 50 graded in handwriting, and as the estimator 207, the information processing device 20 estimates the event 603 of the evaluation criteria table 600 adopted for grading from the image data. In addition, the information processing device 20 associates the grading result in handwriting with the event 603 of the evaluation criteria table 600.

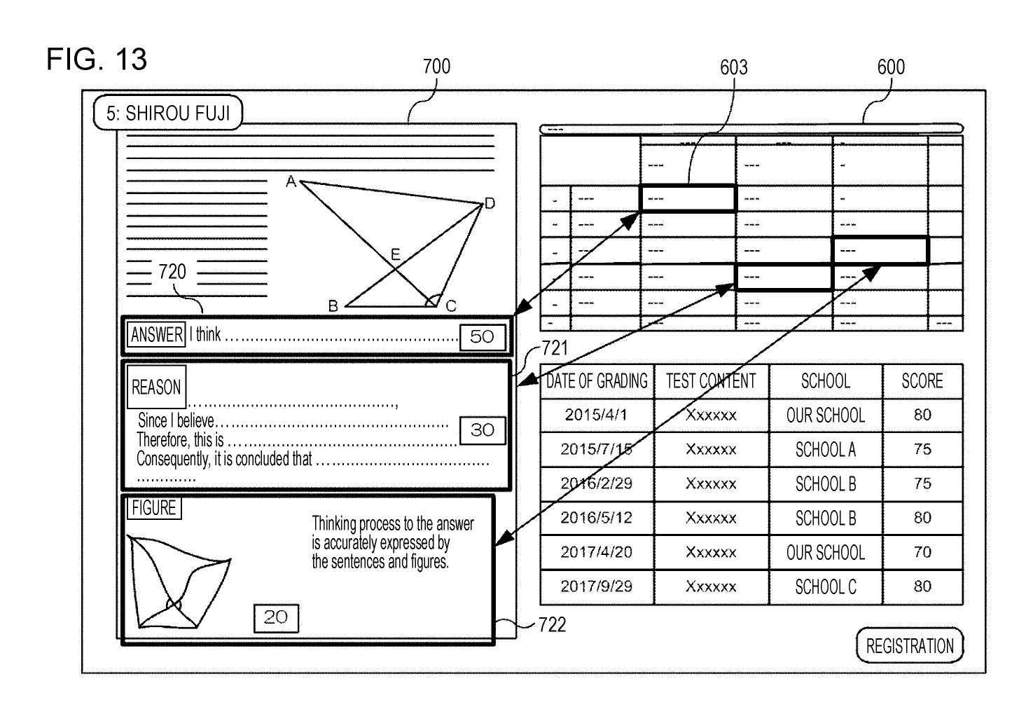

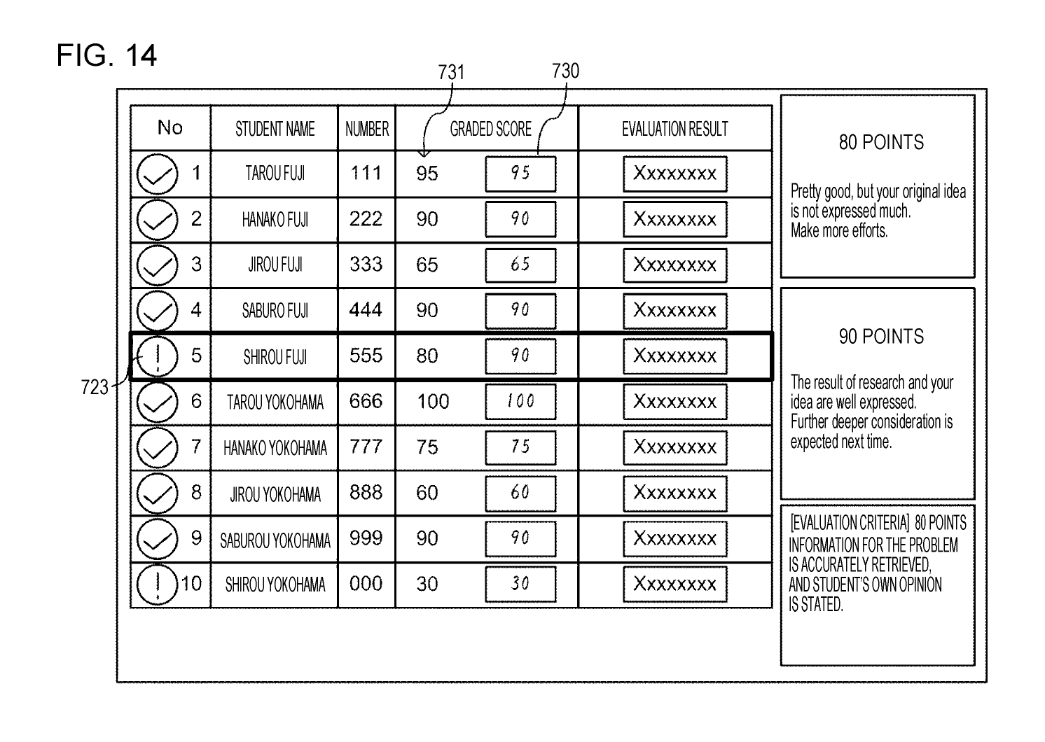

FIG. 12 is a diagram illustrating an operating mode of the information processing device in the third additional exemplary embodiment. FIG. 13 is a view illustrating an example of a screen indicating association between grading results and evaluation criteria. FIG. 14 is a view illustrating an example of a screen which indicates grading results based on evaluation criteria associated with the grading results, and grading results in handwriting by comparison.

As illustrated in FIG. 12, in the third additional exemplary embodiment, grader A first grades the answer sheet 50 in handwriting. The graded answer sheet 50 is converted into image data by the image acquisition device 10, and is acquired by the information processing device 20.

The information processing device 20 displays the screen as illustrated in FIG. 13 on the grader terminal 30 of the grader A. Here, when the grader A grades answers in handwriting, portions of the answer sheet 50 which are the evidences of the evaluation criteria adopted in the evaluation criteria table 600 are surrounded by a frame, or underlined. Hereinafter a case will be described where the portions of the answer sheet 50, which are the evidences, are each surrounded by a rectangle.

As illustrated in FIG. 13, the image 700 of the answer sheet has areas 720 to 722 in handwriting each surrounded by a rectangle. The information processing device 20 recognizes rectangular areas 720 to 722, and further recognizes the scores in the areas 720 to 722. For instance, the scores of 50 points from the area 720, 30 points from the area 721, and 20 points from the area 722 are recognized. In order to increase the accuracy of recognition of scores, the scores may be surrounded by a rectangle in advance in the stage of handwriting. Furthermore, the information processing device 20 identifies which evaluation viewpoints of the evaluation criteria table 600 relate to the rectangular areas 720 to 722, respectively. In order to identify the evaluation viewpoints, the areas 720 to 722 are labeled with symbols indicating the respective evaluation viewpoints related to the areas 720 to 722 in the stage of handwriting. By recognizing the symbols, the information processing device 20 identifies the evaluation viewpoints (columns) of the evaluation criteria table 600, based on which the rectangular areas 720 to 722 are graded. The information processing device 20 calculates the allocation score in the evaluation criteria table 600 backwards from the recognized score mentioned above, and estimates the event 603 which is determined by the combination of the allocation score obtained by the backward calculation, and the identified evaluation viewpoint.

In this manner, for each of the areas 720 to 722, the event 603 of the evaluation criteria table 600, adopted for grading is estimated from the image data of the answer sheet 50. The information processing device 20 calculates a grading result for each of the areas 720 to 722 based on the estimated event 603. Furthermore, as illustrated by double-headed arrows in FIG. 13, the information processing device 20 associates the areas 720 to 722 with respective events adopted for grading based on the above-mentioned estimation result.

In addition, the information processing device 20 displays the screen as illustrated in FIG. 14. In the screen illustrated in FIG. 14, a score image 730 cut out from the image 700 of the answer sheet, and a grading result 731 calculated by the information processing device 20 as the result of the above-mentioned association are displayed side by side. Since the score image 730 is the same as the grading result 731 calculated by the information processing device 20, the proper association of the evaluation viewpoints with the areas 720 to 722 is verified.

Also, the information processing device 20 may receive grading different from grading results in handwriting in accordance with the information processing illustrated in FIG. 5. In this case, in the evaluation criteria table 600 of the screen illustrated in FIG. 13, events 603 different the events 603 associated with the areas 720 to 722 are selected by a grader, and are associated with the areas 720 to 722. In the situation where the idea of the grader A has changed from the idea at the time of handwriting grading, the change can be coped with. When grading on the information processing device 20 is different from the grading at the time of handwriting grading like this, a caution mark 723 illustrated in FIG. 14 is added to the display of a student. For instance, when re-grading gives 80 points by information processing although 90 points is given at the time of handwriting grading, the score image 730 and the grading result 731 have different points like No. 5 student in FIG. 14. When grading different from grading results in handwriting is received in accordance with grading support processing illustrated in FIG. 5, grading may be received from grader B different from grader A.

Also, there is the case where due to a reason that a numeral indicating a score or a symbol indicating an evaluation viewpoint are not clearly written to some extent recognizable by the information processing device 20, a score or a symbol indicating the concept of an evaluation viewpoint may not be recognized. In such a case, it is not possible for the information processing device 20 to associate the evaluation viewpoints with the areas 720 to 722. The information processing device 20 may label with the caution mark 723 to identify the student of the image 700 of the answer sheet for which association is not made.

### Fourth Additional Exemplary Embodiment

In a fourth additional exemplary embodiment, the information processing device 20 supports comparison between grading by multiple graders.

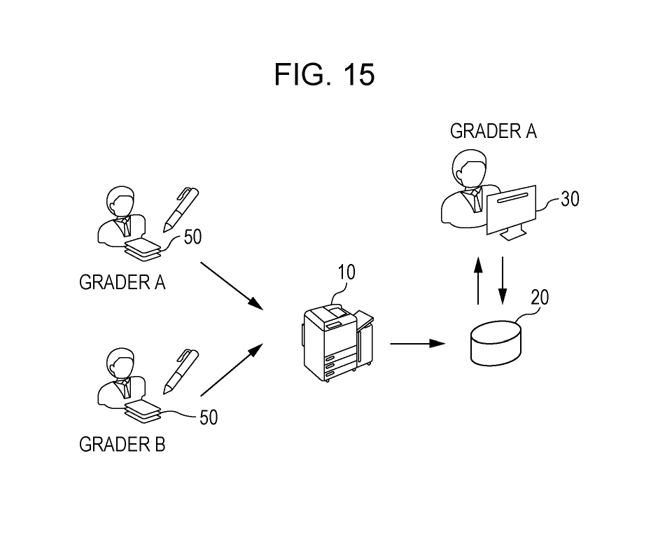

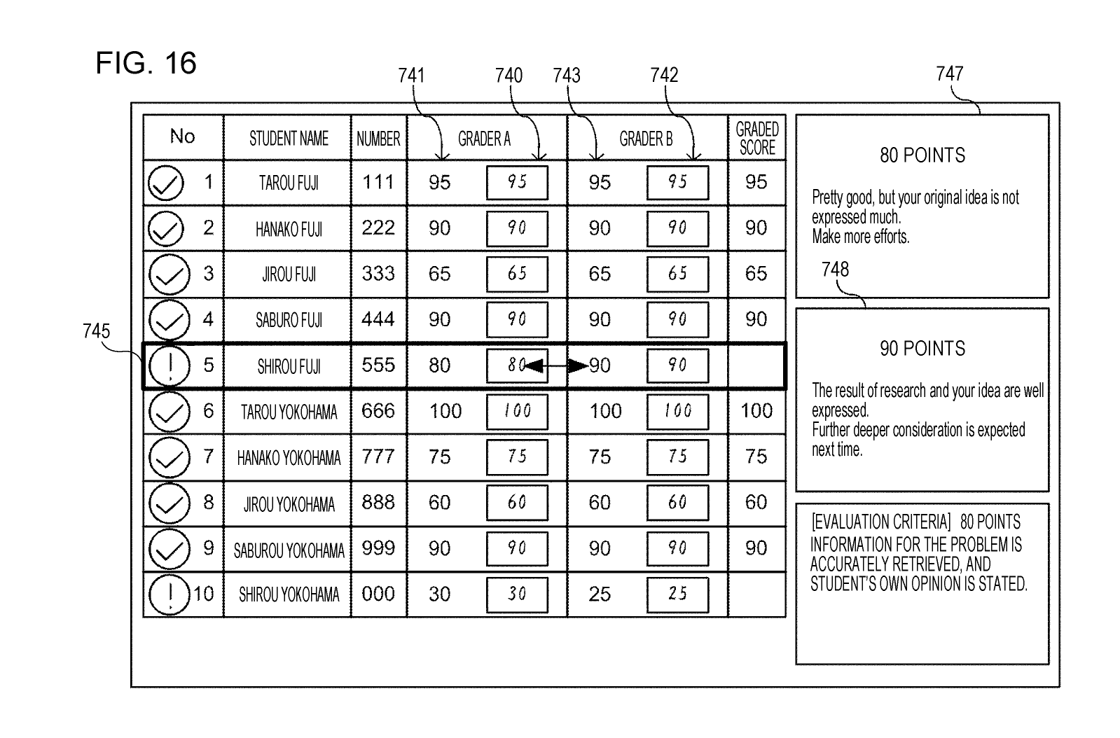

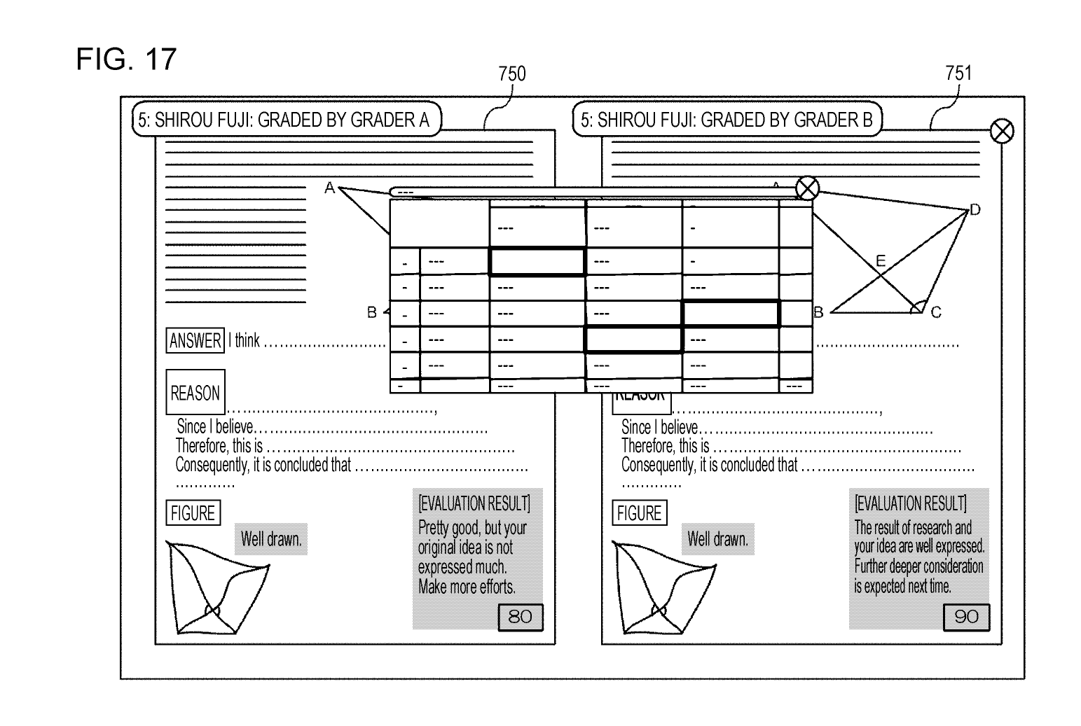

FIG. 15 is a diagram illustrating an operating mode of the information processing device in the fourth additional exemplary embodiment. FIG. 16 is a view illustrating an example of a screen which indicates results of grading by multiple graders by comparison. FIG. 17 is a view illustrating an example of a screen which indicates the details of results of grading by multiple graders by comparison.

In the fourth additional exemplary embodiment, the number of graders may be any number. However, the case where there are two graders will be described below as an example. The answer sheets 50 are prepared by copying so that the number of answer sheets is the same as the number of graders. As illustrated in FIG. 15, in the fourth additional exemplary embodiment, grader A and grader B each grade the answer sheets 50 of all students in handwriting. The graded answer sheets 50 are converted into image data by the image acquisition device 10, and transmitted to the information processing device 20.

The information processing device 20 displays the screen as illustrated in FIG. 16 on the grader terminal 30 of one of the graders, for instance, grader A. The grader A makes comparison between the grading result of himself/herself and the grading result of grader B. The screen in FIG. 16 depicts a score image 740 and a grading result 741 written by grader A as well as a score image 742 and a grading result 743 written by grader B. The score images 740, 742 are images cut out from the images of handwritten answer sheets. Also, similarly to the grading result 731 in the third additional exemplary embodiment, the grading results 741, 743 are obtained by associating grading results in handwriting on the answer sheet with the events 603 of the evaluation criteria table 600.

When the grading results given by grader A and grader B are different, a caution mark 745 is added to the display of the student. For instance, for No. 5 student in FIG. 16, the grading result given by grader A is 80 points, and the grading result given by grader B is 90 points. In such a case, the caution mark 745 is attached. When No. 5 student is selected, a comment 747 made by grader A at the time of grading and a comment 748 made by grader B at the time of grading are displayed on the right side of the screen.

When No. 5 student is further selected with the comments 747, 748 displayed, the information processing device 20 displays the screen illustrated in FIG. 17. In the screen illustrated in FIG. 17, the image 750 of the answer sheet graded in handwriting by grader A and the image 751 of the answer sheet graded in handwriting by grader B are displayed side by side. In addition, the evaluation criteria table 600 referenced by grader A and grader B for grading is also displayed. In the evaluation criteria table 600, the events 603 adopted by grader A and grader B for grading are indicated. For instance, the event adopted by grader A for grading is indicated by surrounding the event with a rectangle in a color (for instance, blue), and the event adopted by grader B for grading is indicated by surrounding the event with a rectangle in another color (for instance, red). Consequently, how the different grader A and grader B have graded the same answer becomes quite obvious. Alternatively, the event 603 adopted by one of grader A and grader B who has given a higher point may be displayed.

Also, in the screen illustrated in FIG. 17, an evaluation viewpoint adopted in the evaluation criteria table may be changed or the evaluation criteria table may be edited in accordance with the information processing of FIG. 5.

### Fifth Additional Exemplary Embodiment

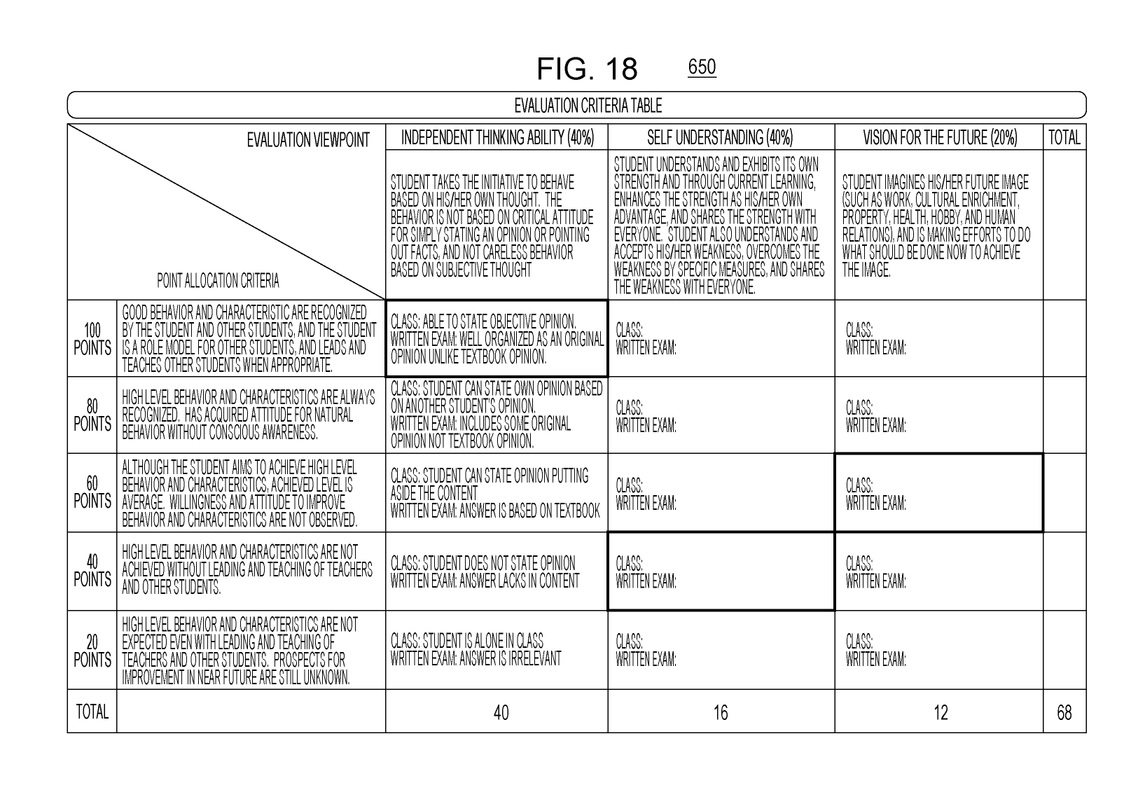

FIG. 18 is a table illustrating an example of another evaluation criteria table.

The evaluation criteria table 600 illustrated in FIG. 4 includes only the contents of answers written on the answer sheets as the evaluation viewpoints, in other words, includes only the viewpoints for evaluating the written contents. However, in addition to the viewpoints for evaluating the written contents, the evaluation criteria table 650 illustrated in FIG. 18 includes viewpoints for evaluating the behavior of students, such as attitudes in class. Like this, the evaluation criteria table 650 may be designed to evaluate written contents and behavior comprehensively. It is to be noted that class may include workshops.

It is to be noted that the above-mentioned information processing can also be implemented by a dedicated hardware circuit. In this case, the information processing may be performed by a single piece of hardware or multiple pieces of hardware.

Also, a program, which causes the information processing device 20 to operate, may be provided by a computer-readable recording medium such as a Universal Serial Bus (USB) memory, a flexible disk, a compact disc read only memory (CD-ROM), or may be provided on-line via a network such as the Internet. In this case, the program recorded on a computer-readable recording medium is normally transferred to and stored in a memory or a storage. Also, the program may be provided as a single application software, or may also be incorporated in software as a function of the information processing device 20.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a presenter that presents evaluation criteria which indicate a plurality of evaluation viewpoints for evaluating an answer, and an allocation score corresponding to each of the plurality of evaluation viewpoints; and
an updater that, when editing of the evaluation criteria is received, updates the evaluation criteria.

2. The information processing device according to claim 1, further comprising:
a grader that receives selection of an evaluation viewpoint and an allocation score used as evaluation of an answer from the evaluation criteria presented by the presenter, and grades the answer with a score corresponding to the selected evaluation viewpoint and allocation score.

3. The information processing device according to claim 2,
wherein when the evaluation criteria are updated by the updater and a graded answer is present which has been graded using the evaluation criteria before update, the grader re-grades the graded answer by the updated evaluation criteria.

4. The information processing device according to claim 3,
wherein when the graded answer is re-graded by the grader using the updated evaluation criteria, the presenter presents a result of grading using the evaluation criteria not updated and a result of grading using the evaluation criteria updated.

5. The information processing device according to claim 1, further comprising
a retriever that retrieves from a database other evaluation criteria similar or related to the evaluation criteria,
wherein the presenter also presents the other evaluation criteria retrieved by the retriever.

6. The information processing device according to claim 2, further comprising
a retriever that retrieves from a database other evaluation criteria similar or related to the evaluation criteria,
wherein the presenter also presents the other evaluation criteria retrieved by the retriever.

7. The information processing device according to claim 3, further comprising
a retriever that retrieves from a database other evaluation criteria similar or related to the evaluation criteria,
wherein the presenter also presents the other evaluation criteria retrieved by the retriever.

8. The information processing device according to claim 4, further comprising
a retriever that retrieves from a database other evaluation criteria similar or related to the evaluation criteria,
wherein the presenter also presents the other evaluation criteria retrieved by the retriever.

9. The information processing device according to claim 5,
wherein the retriever retrieves from the database the other evaluation criteria along with a result of grading of other answers graded using the other evaluation criteria, and
the presenter presents the other evaluation criteria along with the result of grading of the other answers.

10. The information processing device according to claim 6,
wherein the retriever retrieves from the database the other evaluation criteria along with a result of grading of other answers graded using the other evaluation criteria, and
the presenter presents the other evaluation criteria along with the result of grading of the other answers.

11. The information processing device according to claim 7,
wherein the retriever retrieves from the database the other evaluation criteria along with a result of grading of other answers graded using the other evaluation criteria, and
the presenter presents the other evaluation criteria along with the result of grading of the other answers.

12. The information processing device according to claim 8,
wherein the retriever retrieves from the database the other evaluation criteria along with a result of grading of other answers graded using the other evaluation criteria, and
the presenter presents the other evaluation criteria along with the result of grading of the other answers.

13. The information processing device according to claim 1, further comprising
a registry unit that registers part or all of answers, which is allowed to be referenced when another answer is graded or after another answer is graded.

14. The information processing device according to claim 2, further comprising
a registry unit that registers part or all of answers, which is allowed to be referenced when another answer is graded or after another answer is graded.

15. The information processing device according to claim 3, further comprising
a registry unit that registers part or all of answers, which is allowed to be referenced when another answer is graded or after another answer is graded.

16. The information processing device according to claim 1, further comprising:
an acquirer that acquires image data of an answer sheet on which the answer and the result of grading are written; and
an estimator that estimates an evaluation viewpoint and an allocation score of the evaluation criteria used for the result of grading, based on the image data acquired by the acquirer,
wherein the presenter presents a score based on the evaluation viewpoint and the allocation score estimated by the estimator.

17. The information processing device according to claim 16,
wherein the presenter presents an image related to score cut out from the answer sheet, and the allocation score estimated by the estimator to allow comparison between the image related to score and the allocation score.

18. The information processing device according to claim 16,
wherein the acquirer acquires image data of a plurality of answer sheets on which different results of grading are written for the same answer, each of the answer sheets being the answer sheet, and
the presenter presents a plurality of allocation scores, each of which is the allocation score, estimated by the estimator to allow comparison between the plurality of allocation scores based on the image data of the plurality of answer sheets.

19. An information processing method comprising:
presenting evaluation criteria which indicate a plurality of evaluation viewpoints for evaluating an answer, and an allocation score corresponding to each of the plurality of evaluation viewpoints; and
when editing of the evaluation criteria is received, updating the evaluation criteria.

20. A non-transitory computer readable medium storing an information processing causing a computer to execute a process, the process comprising:
presenting evaluation criteria which indicate a plurality of evaluation viewpoints for evaluating an answer, and an allocation score corresponding to each of the plurality of evaluation viewpoints; and
when editing of the evaluation criteria is received, updating the evaluation criteria.
